(19) United States
(12) Patent Application Publication
(10) Pub. No.: US 2005/0088093 A1
(43) Pub. Date: Apr. 28, 2005

(54) Plasma display apparatus

(76) Inventors: Eun-Gon Kim, Suwon-si (KR); Hak-Bae Kim, Suwon-si (KR); Ki-Jung Kim, Suwon-si (KR)

Correspondence Address: MCGUIREWOODS, LLP, 1750 TYSONS BLVD, SUITE 1800, MCLEAN, VA, 22102, US

(21) Appl. No.: 10/969,004

(22) Filed: Oct. 21, 2004

(30) Foreign Application Priority Data
Oct. 23, 2003 (KR) 10-2003-0074230

(51) Int. Cl. H01J 17/49

(52) U.S. Cl. 313/582; 313/583; 313/584

(57) ABSTRACT

The present invention provides an improved plasma display apparatus which is configured to prevent electrical shorts in a connection between a plasma display panel (PDP and a driving circuit. In one embodiment the plasma display apparatus includes a plasma display panel, and a chassis base positioned proximate and proceeding substantially parallel the plasma display panel. The chassis base has a surface contacting the plasma display panel, and an opposite surface on which the driving circuit is mounted. A connector electrically connects the plasma display panel to the driving circuit unit. At least one spacer member is disposed between the chassis base and the connector to space the chassis base and the connector from each other with a gap.

### CROSS-REFERENCE TO RELATED APPLICATIONS

This application claims priority of Korean Application 2003-0074230 filed in the Korean Patent Office on Oct. 23, 2003, the disclosure of which is herein incorporated by reference.

### BACKGROUND OF THE INVENTION

1. Field of the Invention

The present invention relates to plasma display panels (PDPs) generally, and more particularly, to a structure for connecting a PDP to a circuit unit.

A PDP is a display device that uses a plasma phenomenon to create and display color images. Each PDP includes millions of discharge cells. Each discharge cell is defined by barrier ribs formed between an upper substrate and a lower substrate. A dielectric layer is formed on each substrate, and crossed electrodes intersect each cell. The interior of each cell contains gas in a vacuum state, and is lined with a substrate that emits visible colored light when stimulated by ultraviolet radiation.

2. Description of Related Art

Sustain electrodes (or X electrodes) and scan electrodes (or Y electrodes) are marked on the upper substrate, and address electrodes are mounted on the lower substrate. In use, a voltage difference applied to the intersecting electrodes excites the gas atoms to release photons which impinge the colored phosphor that lines each cell. The phosphor absorbs the incident photon and emits visible colored light. By selectively activating various combinations of electrodes, color images may be created.

In the conventional PDP described above, a drive voltage is supplied to the address electrodes and the scan electrodes to thereby affect an address discharge between the same. This creates wall charges on the dielectric layers of the upper and lower substrates. Additionally, in the cells selected by the address discharge, a sustain discharge may be created by applying an alternating signal to the scan electrodes and the sustain electrodes.

Electrodes formed on the plasma display panel are electrically connected to a driving circuit, and a driver integrated circuit (IC) applies address voltages to the electrodes in accordance with the signals controlled at the driving circuit.

Various voltage application structures use the driver IC, including a chip on board (COB) structure where the ICs are mounted on a printed circuit board (PCB), and a chip on film (COF) structure where the ICs are directly mounted on an FPC formation film. The recent trend is to use a low cost tape carrier package (TCP) as the voltage application structure. For example, an exemplary TCP and methods of manufacturing the same are described in chapter 12 of the 2000 Packaging Deskbook published by Intel Corporation of Santa Clara, Calif.

A conventional TCP may be sided with the chassis base to selectively apply voltages to the electrodes of the plasma display panel via the driver IC. The conventional TCP may include a TCP tape formed of a sequentially deposited base film, copper foil pattern, and solder resist layer. The driver IC may be electrically connected to the copper foil pattern via a lead. However, as the surface of the TCP tape contacts the surface of the chassis base, rough protrusions formed on the surface of the chassis base may penetrate the solder resist layer, and contact the copper foil pattern, thereby causing an electrical short, which may seriously damage both the driver IC and the plasma display panel. The effects of such a short may also reduce display device's reliability. An improved PDP is needed that avoids electrical shorts between a TCP tape and a chassis, and that benefits from improved reliability and picture quality.

### SUMMARY OF THE INVENTION

In one embodiment of the invention, an improved plasma display apparatus is provided which is configured to prevent electrical shorts in a connection between a PDP chassis and a driving circuit. According to one embodiment of the present invention, the improved PDP includes a plasma display panel and a chassis base. The chassis base proceeding substantially parallel to the plasma display panel and has a surface that contacts the plasma display panel. A driving circuit unit is mounted on an opposite surface of the chassis base. The plasma display panel is electrically connected to the driving circuit unit via a connector. The connector has a driver IC facing the chassis base and is packaged in the form of a tape carrier package (TCP). A TCP tape electrically connects the driver IC to the plasma display panel.

At least one spacer member is disposed between the chassis base and the connector to space the chassis base and the connector from each other with a predetermined gap therebetween. The spacer member has at least one protrusion formed on the connector facing the chassis base, and the protrusion is formed with a rectangular or circular cross section. Alternatively, the spacer member may have at least one protrusion formed on the TCP tape facing the chassis base, and the protrusion may be formed with a rectangular or circular cross section.

The spacer member may also have a resin layer formed on the connector facing the chassis base, and the resin layer may be formed of a material selected from the group consisting of epoxy resin and flex resin.

Furthermore, the spacer member may have a resin layer formed on the TCP tape facing the chassis base, and the resin layer may be formed of a material selected from the group consisting of epoxy resin and flex resin.

A compression plate may be placed parallel to the chassis base while facing the driver IC. In such an embodiment, a thermal conduction medium may be disposed between the compression plate and the driver IC. The thermal conduction medium may be formed with a silicon sheet.

In another embodiment, a thermal conduction medium may be disposed between the chassis base and the driver IC. The thermal conduction medium may be formed of silicon oil or thermal grease.

Additionally, a high thermal conduction solid member, formed of a material selected from aluminum, copper, or iron, may be attached to the chassis base while facing the connector. In such an embodiment, a thermal conduction medium may be disposed between the high thermal conduction solid member and the driver IC. The thermal conduction medium may be formed of silicon oil or thermal grease.

### BRIEF DESCRIPTION OF THE DRAWINGS

The above and other advantages of the present invention will become more apparent by describing preferred embodiments thereof in detail with reference to the accompanying drawings.

FIG. 1 is a sectional view of a plasma display apparatus according to one embodiment of the present invention.

FIG. 2 is a plan view of a circuit connection unit for the plasma display apparatus shown in FIG. 1.

FIGS. 3A and 3B illustrate variants of the circuit connection unit shown in FIG. 2.

FIG. 4 is a sectional view of a plasma display apparatus according to another embodiment of the present invention.

FIGS. 5A and 5B are sectional views of a plasma display apparatus according to yet another embodiment of the present invention.

FIGS. 6A and 6B are sectional views of a plasma display apparatus according to another embodiment of the present invention.

FIGS. 7A and 7B are sectional views of a plasma display apparatus according to another embodiment of the present invention.

### DETAILED DESCRIPTION OF PREFERRED EMBODIMENTS

Embodiments of the invention provide an improved PDP configured to prevent electrical shorts from occurring between a driving circuit and the PDP chassis.

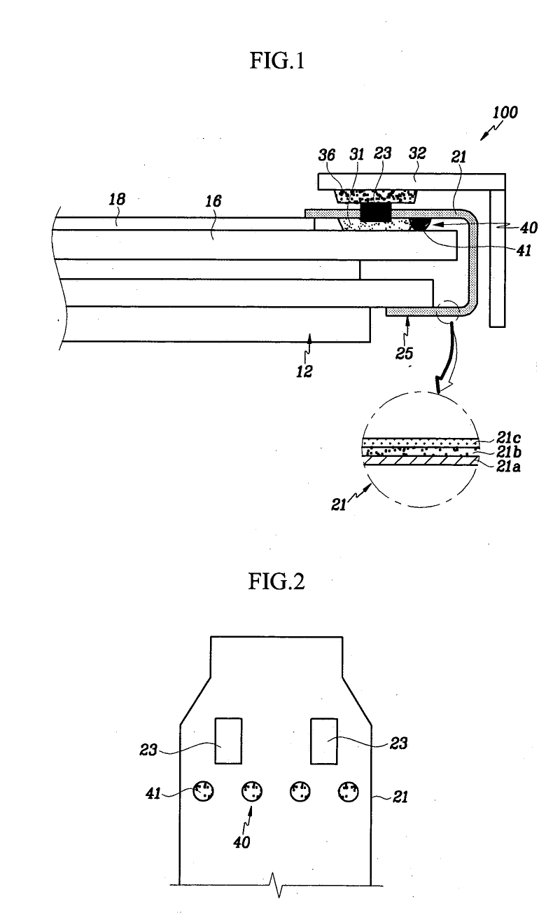

FIG. 1 is a sectional view of plasma display apparatus according to one embodiment of the present invention. As shown in FIG. 1, the plasma display apparatus 100 includes a plasma display panel (referred to hereinafter simply as a “PDP”) 12, and a chassis base 16. The PDP 12 is mounted on one side surface of the chassis base 16, and a driving circuit unit 18 is mounted on the opposite side surface of the chassis base 16 to drive the PDP 12. The PDP 12 has a structure where the electrodes for receiving the required signals for driving the image display are drawn from the periphery thereof. The electrodes are electrically connected to the driving circuit unit 18 via a circuit connection unit 25 to receive the signals for driving the PDP 12.

The circuit connection unit 25 is structured as a type of tape carrier package (TCP), and has a TCP tape 21 electrically connecting the electrode of the PDP 12 to the driving circuit unit 18. Additionally, a driver IC 23 is mounted on the TCP tape 21.

In one embodiment, the TCP tape 21 extends from the periphery of the PDP 12 to the periphery of the driving circuit unit 18 while interposing between the chassis base 16 and a compression plate 32 to electrically connect the electrodes of the PDP 12 to the driving circuit unit 18. The TCP tape 21 may include a layered flexible printed circuit (FPC), that has a base film 21a, a copper foil layer 21b attached on the base film 21a, and a solder resist layer 21c deposited on the copper foil layer 21b. As shown, the TCP tape 21 may be placed such that the surface of the solder resist layer 21c faces the chassis base 16.

The driver IC 23 has the form of a package and is mounted through a hole formed at the TCP tape 21 to electrically connect the electrodes of the PDP 12 to the copper foil layer 21b of the TCP tape 21 via a bump (not shown). The driver IC 23 selectively applies predetermined voltages to the electrodes of the PDP 12 in accordance with the signals controlled at the driving circuit unit 18.

As illustratively shown, a liquid or gel thermal conduction medium 31 is disposed between the driver IC 23 and the chassis base 16. The thermal conduction medium 31 conducts the heat generated from the driver IC 23 to the chassis base 16. The thermal conduction medium 31 is liquid or gel at the operational temperature of the PDP 12, and the thermal conductivity thereof is preferably 0.1 W/mK or more. Particularly, the liquid or gel thermal conduction medium 31 is formed of silicon oil or thermal grease. Heat generated from the driver IC 23 is conducted to the chassis base 16 via the thermal conduction medium 31, and discharged to the exterior of the PDP.

In one embodiment, the compression plate 32 is positioned external to the driver IC 23 to compress the driver IC 23 toward the chassis base 16. The compression plate 32 and the chassis base 16 may be formed with a material such as aluminum, copper, or iron. The compression plate 32 may be coupled to the chassis base 16 via a coupling member, such as a screw.

A thermal conduction medium 36 is disposed between the compression plate 32 and the driver IC 23. The thermal conduction medium 36 conducts the heat generated from the driver IC 23 to the compression plate 32. The thermal conduction medium 36 may be formed with a silicon sheet attached to the compression plate 32. The heat generated from the driver IC 23 is conducted to the compression plate 32 via the thermal conduction medium 36.

In a plasma display apparatus 100, configured as described above, when the driver IC 23 is closely fitted to the chassis base 16 via the compression plate 32, the TCP tape 21 of the circuit connection unit 25 is also fitted to the chassis base 16. Consequently, the fine and rough surface protrusions of the chassis base 16 may penetrate the solder resist layer 21c of the TCP tape, and contact the copper foil layer 21b, thereby causing an electrical short.

To prevent punctures and electrical shorts from occurring, a spacer member 40 is formed between the surface of the TCP tape 21 and the surface of the chassis base 16 to form a predetermined gap between them.

The spacer member 40 has at least one protrusion 41 formed on the surface of the TCP tape 21 facing the chassis base 16, that is, on the surface of the solder resist layer 21c. The protrusion 41 may be formed of epoxy resin or flex resin. As known in the art, epoxy resin is gradually hardened from the liquid phase, and is rigidly solidified. Flex resin, by contrast, is gradually hardened from the liquid phase to a soft structure. The spacer member 40 is closely fitted to the surface of the chassis base 16 by the compressing of the compression plate 32 to form a gap between the surface of the TCP tape 21 and the surface of the chassis base 16. The gap keeps the rough protrusions formed on the chassis base 16 from causing an electrical short by penetrating the solder resist layer 21c of the TCP tape 21 and contacting the thin copper layer 21b.

Furthermore, an air flow stream is made at the bottom of the chassis base 16 due to the gap, which cools the heat generated from the driver IC 23 and the copper foil layer 21b of the TCP tape 21. The air with a relatively low temperature formed at the bottom of the chassis base 16 due to natural convention flows through the gap to effectively reduce the temperature of the driver IC 23 and the copper foil layer 21b.

FIG. 2 is a plan view of the circuit connection unit shown in FIG. 1.

As shown in FIG. 2, a plurality of protrusions 41 are formed on the TCP tape 21, and each protrusion 41 has a circular cross-section. The protrusions 41 may be arranged proximate the driver IC 23. The protrusions 41 are positioned on the TCP tape 21 and spaced apart from each other with a predetermined distance therebetween.

For example, it is preferable that the width of the TCP tape 21 is about 40 mm, each diameter of protrusions 41 is about 2.5 mm, the distance between the protrusions 41 neighboring each other on forming four protrusions 41 along the width direction of the TCP tape 21, is about 6 mm.

The spacing between the protrusions 41 is configured to form an air flow passage between them, through which the above-described air flow stream formed at the bottom of the chassis base 16 may pass.

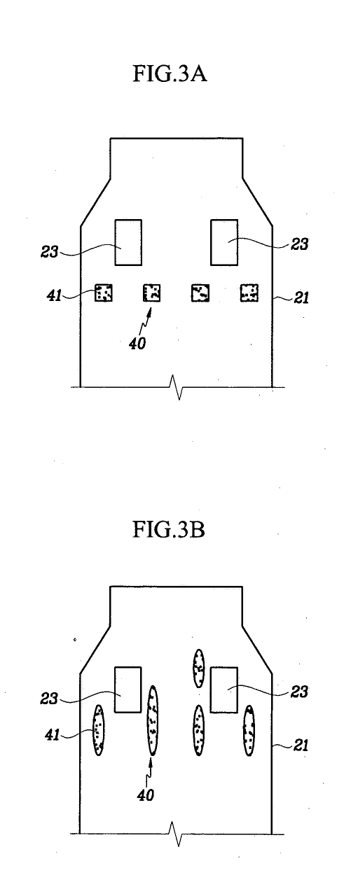

FIGS. 3A and 3B illustrate variants of the circuit connection unit shown in FIG. 2. As shown in FIG. 3A, a plurality of protrusions 41 are formed on the TCP tape 21, and each protrusion has a rectangular cross-section. As shown in FIG. 3B, a plurality of protrusions 41 formed on the TCP tape 21 may have substantially oblong shapes that are positioned in a substantially longitudinal direction. In other embodiments, the protrusions 41 may have any other conceivable shape and may be positioned on the TCP in any suitable direction.

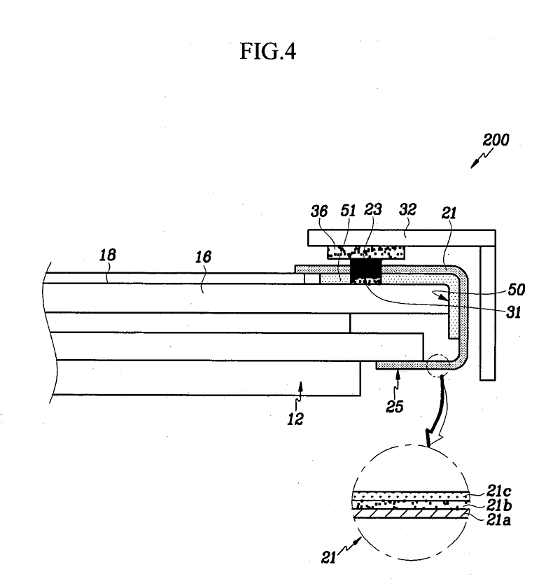

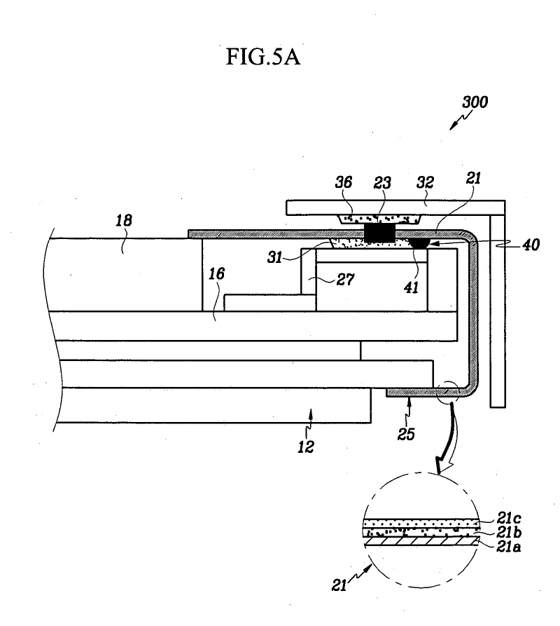

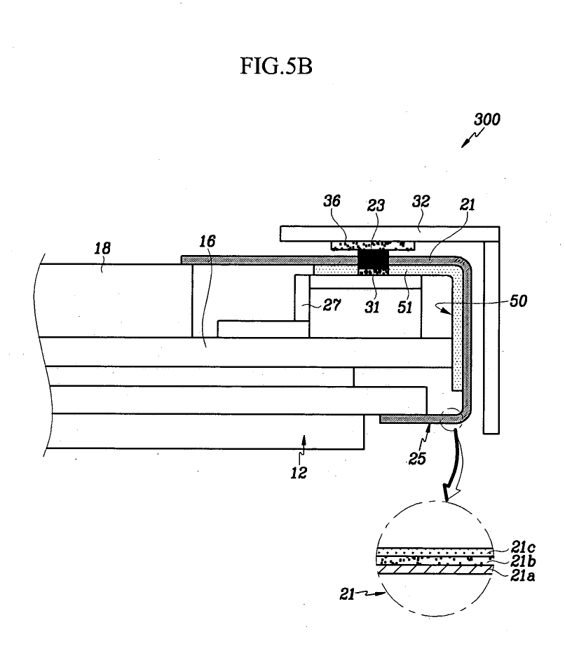

FIG. 4 is a sectional view of a plasma display apparatus according to a second embodiment of the present invention.

As shown in FIG. 4, the plasma display apparatus 200 has a spacer member 50 with a resin layer 51 formed on the surface of the TCP tape 21 facing the chassis base 16.

The resin layer 51 is formed by coating flex resin in the phase of a liquid and hardening it to a soft firmness. Illustratively, the resin layer 51 may be formed on the surface of the TCP tape 21 except for the portion of the driver IC 23, using a silk screening technique.

As the resin layer 51 is placed between the chassis base 16 and the TCP tape 21, the rough protrusions formed on the chassis base 16 are prevented from penetrating the solder resist layer 21c of the TCP tape 21 when a compressive force is applied by compression plate 32.

FIGS. 5A and 5B are sectional views of a plasma display apparatus according to another embodiment of the present invention. As shown in FIGS. 5A and 5B, the plasma display apparatus 300 has a structure similar to that of the previous embodiments of the present invention, a difference being that a high thermal conduction solid member 27 is attached to the chassis base 16 facing the driver IC 23.

The high thermal conduction solid member 27 is placed between the chassis base 16 and the driver IC 23 while laterally proceeding along the periphery of the chassis base 16. In case, the high thermal conduction solid member 27 conducts heat generated from the driver IC 23 to the chassis base 16. The high thermal conduction solid member 27 and the chassis base 16 may be formed of the same or similar heat-conductive material, such as but not limited to, aluminum, copper, or iron.

A liquid or gel thermal conduction medium 31 may be disposed between the driver IC 23 and the high thermal conduction solid member 27 to conduct the heat generated from the driver IC 23 to the chassis base 16. For example, the heat generated by operation of the driver IC 23 is conducted to the high thermal conduction solid member 27, and then to the chassis base 16 via the thermal conduction medium 31 to be discharged to the exterior of the PDP.

Meanwhile, the spacer member 40 or 50 is formed on the TCP tape 21 facing the high thermal conduction solid member 27. Therefore, with the compression of the compression plate 32, the spacer member 40 or 50 is closely fitted to the surface of the high thermal conduction solid member 27, thereby forming a predetermined gap between the TCP tape 21 and the high thermal conduction solid member 27.

As a gap is formed between the TCP tape 21 and the high thermal conduction solid member 27 due to the spacer member 40 or 50, the rough protrusions formed on the high thermal conduction solid member 27 are prevented from penetrating the solder resist layer 21c of the TCP tape 21 and causing an electrical short with the copper foil layer 21b.

As other structures are the same as those related to the previously described embodiments of the present invention, detailed explanation thereof is omitted.

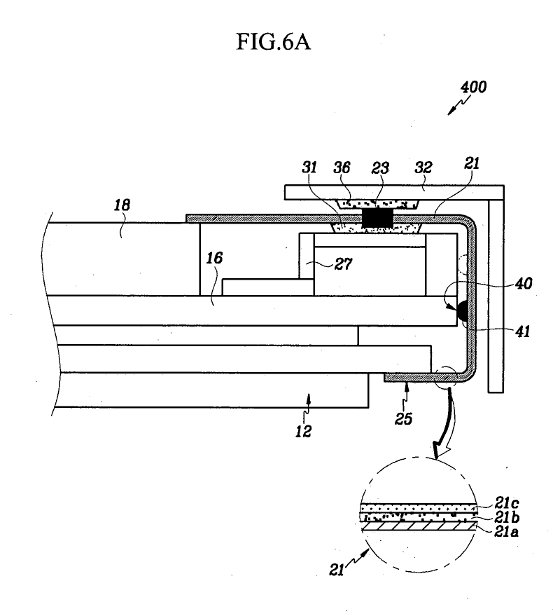

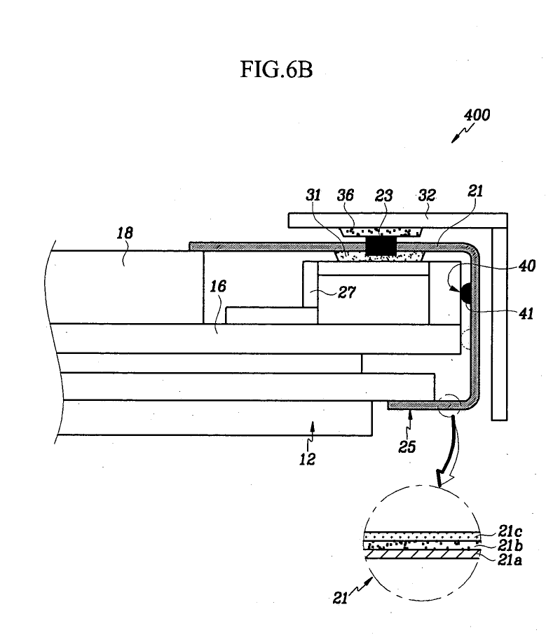

FIGS. 6A and 6B are sectional views of a plasma display apparatus according to another embodiment of the present invention.

As shown in FIGS. 6A and 6B, the plasma display apparatus 400 has a structure related to the previously described embodiments of the present invention. A spacer member 40 is placed on the TCP tape 21 substantially contacting the chassis base 16 or the high thermal conduction solid member 27.

Specifically, in this embodiment, the spacer member 40 is placed not on the surface of the TCP tape 21 positioned close to the driver IC 23, but on the surface of the TCP tape 21 that extends from the periphery of the PDP 12 while contacting the periphery of the chassis base 16 or the high thermal conduction solid member 27.

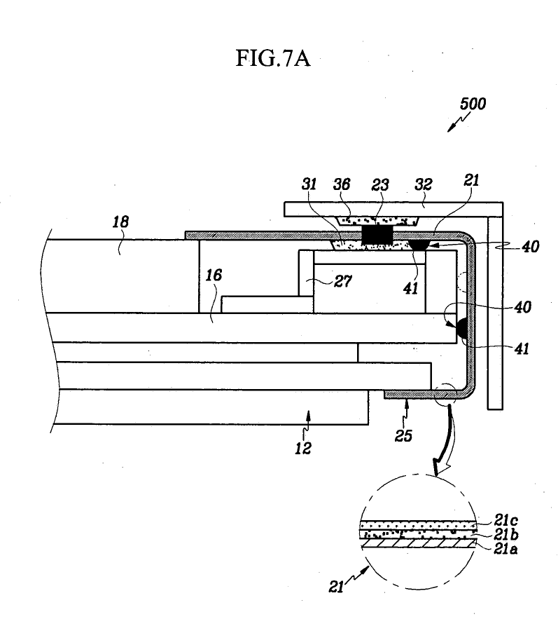

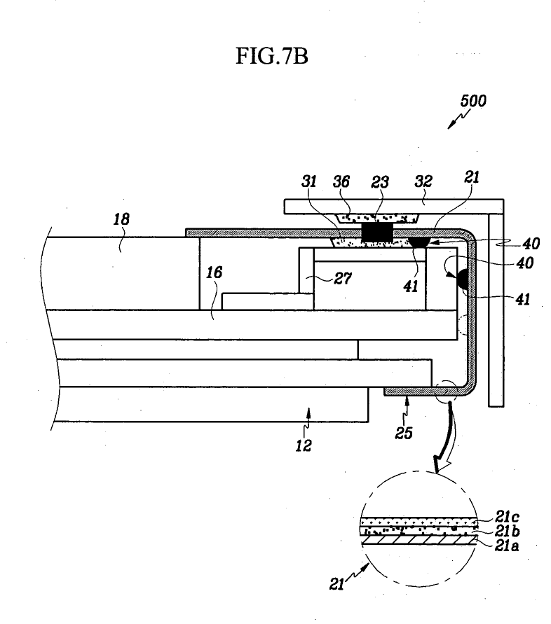

FIGS. 7A and 7B are sectional views of a plasma display apparatus according to another embodiment of the present invention. As shown in FIGS. 7A and 7B, the plasma display apparatus 500 may include a spacer member 40 formed on the surface of the TCP tape 21 proximate the driver IC 23, and a second spacer member 40 formed on the surface of a portion of the TCP tape 21 that extends from the periphery of the PDP 12. The latter spacer member 40 may contact the periphery of the chassis base and the former may contact a portion of the high thermal conduction solid member 27. However, the invention is not limited to the arrangement of spacers shown, but may include other suitable configurations.

As described above, in embodiments of an improved plasma display apparatus, a spacer member is formed between the chassis base or the high thermal conduction solid member, and the circuit connection unit. Consequently, a possible short of the chassis base or the high thermal conduction solid member with a circuit connection unit due to the surface roughness thereof is prevented, thereby enhancing the reliability of the display device.

Furthermore, as the spacer member may be configured to form an air passage is formed between the chassis base or the high thermal conduction solid member, and the circuit connection unit, the heat generated from the driver IC and the circuit connection unit is cooled by the air flow passing through the air passage. This maintains the temperature of the driver 1C within acceptable operating limits.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. A plasma display apparatus, comprising:
a plasma display panel;
a chassis base positioned proximate and substantially parallel the plasma display panel, the chassis base having a surface contacting the plasma display panel, and an opposite surface on which a driving circuit unit is mounted;
a connector electrically connecting the plasma display panel to the driving circuit unit; and
at least one spacer member disposed between the chassis base and the connector to space the chassis base and the connector from each other with a gap.

2. The plasma display apparatus of claim 1, wherein the connector comprises:
a driver integrated circuit (IC) facing the chassis base and packaged in the form of a tape carrier package (TCP); and
a TCP tape electrically connecting the driver IC to the plasma display panel.

3. The plasma display apparatus of claim 1, wherein the spacer member has at least one protrusion formed on the connector and facing the chassis base.

4. The plasma display apparatus of claim 3, wherein the protrusion is formed with a substantially rectangular or circular cross section.

5. The plasma display apparatus of claim 2, wherein the spacer member has at least one protrusion formed on the TCP tape and facing the chassis base.

6. The plasma display apparatus of claim 5, wherein the protrusion is formed with a rectangular or circular cross section.

7. The plasma display apparatus of claim 1, wherein the spacer member has a resin layer formed on the connector and facing the chassis base.

8. The plasma display apparatus of claim 7, wherein the resin layer is formed of a material selected from the group consisting of epoxy resin and flex resin.

9. The plasma display apparatus of claim 2, wherein the spacer member has a resin layer formed on the TCP tape and facing the chassis base.

10. The plasma display apparatus of claim 9, wherein the resin layer is formed of a material selected from the group consisting of epoxy resin and flex resin.

11. The plasma display apparatus of claim 2, wherein a compression plate is positioned parallel to the chassis base with a portion of the compression plate facing the driver IC.

12. The plasma display apparatus of claim 11, wherein a thermal conduction medium is disposed between the compression plate and the driver IC.

13. The plasma display apparatus of claim 12, wherein the thermal conduction medium is formed of a silicon sheet.

14. The plasma display apparatus of claim 12, wherein a thermal conduction medium is disposed between the chassis base and the driver IC.

15. The plasma display apparatus of claim 14, wherein the thermal conduction medium is formed of silicon oil or thermal grease.

16. The plasma display apparatus of claim 1, further comprising a high thermal conduction solid member attached to the chassis base and facing the connector.

17. The plasma display apparatus of claim 16, wherein a thermal conduction medium is disposed between the high thermal conduction solid member and the driver IC.

18. The plasma display apparatus of claim 17, wherein the thermal conduction medium is formed of silicon oil or thermal grease.

19. The plasma display apparatus of claim 16, wherein the high thermal conduction solid member is formed of a material selected from the group consisting of aluminum, copper, or iron.
